(19) United States
(12) Patent Application Publication
(10) Pub. No.: US 2019/0101206 A1
(43) Pub. Date: Apr. 4, 2019

(54) INTEGRATED SLEW DRIVE

(71) Applicant: Kinematics, LLC, Huntington Beach, CA (US)

(72) Inventors: Adam P. Plesniak, Huntington Beach, CA (US); Kenneth D. Miller, Statesville, NC (US); Kyle Zech, Phoenix, AZ (US); Mark Henderson, La Verne, CA (US)

(73) Assignee: Kinematics, LLC, Huntington Beach, CA (US)

(21) Appl. No.: 16/133,375

(22) Filed: Sep. 17, 2018

Related U.S. Application Data
(60) Provisional application No. 62/565,513, filed on Sep. 29, 2017.

(51) Int. Cl. F16H 57/039; F16H 1/16; F16H 57/025

(52) U.S. Cl. CPC F16H 57/039; F24S 30/45; F16H 57/025; F16H 1/16

(57) ABSTRACT

A slew drive comprises a slew drive housing which includes a first distal housing section and a second distal housing section. The first distal housing section includes a threaded section, operative to receive a threaded plug and the second distal housing section includes a groove operative to receive a retaining ring. A worm gear is secured to the slew drive housing by a first tapered roller bearing and a second tapered roller bearing. The worm gear comprises a central threaded section, a first distal shaft section having a first shoulder, and a second distal shaft section having a second shoulder. The central threaded section engages the teeth of a worm wheel, the first tapered roller bearing is seated on the first distal shaft section, abutting the first shoulder and the plug, and the second tapered roller bearing is seated on the second distal shaft section, abutting the second shoulder and the retaining ring.

### CROSS REFERENCE TO RELATED APPLICATIONS

The present patent application is a formalization of a previously filed co-pending provisional patent application entitled “Integrated Slew Drive,” filed on 2017 Sep. 29, as U.S. patent application Ser. No. 62/565,513 by the inventor(s) named in this application. This patent application claims the benefit of the filing date of the cited provisional patent application according to the statutes and rules governing provisional patent applications, particularly 35 USC § 119 and 37 CFR § 1.78. The specification and drawings of the cited provisional patent application are specifically incorporated herein by reference.

### COPYRIGHT

A portion of the disclosure of this patent document contains material which is subject to copyright protection. The owner has no objection to the facsimile reproduction by anyone of the patent disclosure, as it appears in the Patent and Trademark Office files or records, but otherwise reserves all copyright rights whatsoever.

### FIELD OF INVENTION

The present invention relates to slew drives which include a worm gear and a worm wheel that are secured within a housing. In particular, the housing includes a first distal housing section and a second distal housing section which operate to receive a threaded plug and a retaining ring so as to reduce the number of components used in the assembly of such slew drives. The first distal housing section includes a threaded section operative to engage the threaded plug and the second distal housing section includes a groove operative to receive the retaining ring.

### BACKGROUND

A slew drive is a type of gearbox which can withstand axial and radial loads while transmitting torque to drive an external unit. Applications where a slew drive is utilized include solar trackers, wind turbines, lifts, and cranes, to name a few. Slew drives generally include a threaded shaft having a threaded section, commonly referred to as the worm gear and a geared wheel having teeth, commonly referred to as the worm wheel. The threaded section of the worm gear engages the teeth of the worm wheel thereby rotating the worm wheel. The worm gear rotates along its own axial axis at a rotational speed causing the worm wheel to rotate along its axial axis at a different rotational speed. The axes of rotation of the worm gear and worm wheel are, in general, perpendicular, although they can be at a different angle.

A slew drive further includes bearings, seals, and other components which are secured within a housing. The housing includes two ends where two bearings, such as two tapered roller bearings, are positioned. The worm gear is secured to the housing via the two bearings. The seals operate to maintain the lubricants within the housing. The housing of a conventional slew drive includes two end caps and a number of bolts, typically 4 on each side, in order to exert an axial compressive force on the worm gear which in turn exerts the axial force on the teeth of the work wheel. This configuration ensures improved engagement between the threads of the worm gear and the teeth of the worm wheel.

An objective of the present design is to replace the two end caps and the associated bolts with a threaded plug and a retaining ring. This configuration reduces costs in material and labor. Specifically, the number of components used in the slew drive are reduced thereby lowering the cost of material, and at the same time making the assembly of the slew drive easier and less labor intensive thereby lowering the cost of labor.

### SUMMARY

In one aspect, a slew drive is disclosed wherein the slew drive comprises a threaded plug, a retaining ring, a housing comprising a first distal housing section and a second distal housing section, wherein the first distal housing section includes a threaded section operative to receive the threaded plug, wherein the second distal housing section includes a groove operative to receive the retaining ring, a worm gear comprising a central threaded section, a first distal shaft section including a first shoulder, and a second distal shaft section including a second shoulder, a first bearing seated on the first distal shaft section and abutting the first shoulder and the threaded plug, a second bearing seated on the second distal shaft section and abutting the second shoulder and the retaining ring, and a worm wheel comprising worm-wheel teeth operative to engage the central threaded section of the worm gear, whereby rotating the threaded plug in engagement with the threaded section, a compressive force is exerted upon the worm gear.

Preferably, at least one of the first bearing and the second bearing comprises one of a roller bearing and a ball bearing.

Preferably, the roller bearing comprises one of a tapered roller bearing, a cylindrical roller bearing, a spherical roller bearing, and a needle roller bearing.

Preferably, the ball bearing comprises one of a deep groove ball bearing, an angular ball bearing, and a thrust ball bearing.

Preferably, the first bearing is seated on the first distal shaft section via one of a clearance fit, a transition fit, and an interference fit.

Preferably, the retaining ring is a circlip.

Preferably, the slew drive further comprises at least one of thread lock and sealant applied over the first distal housing section.

Preferably, the slew drive further comprises an oil seal disposed within the second distal housing section.

In another aspect, a housing in combination with a slew drive is disclosed wherein the slew drive comprises a threaded plug, a retaining ring, a worm gear comprising a central threaded section, a first distal shaft section including a first shoulder, and a second distal shaft section including a second shoulder, a first bearing seated on the first distal shaft section and abutting the first shoulder and the plug, a second bearing seated on the second distal shaft section and abutting the second shoulder and the retaining ring, and a worm wheel comprising worm-wheel teeth operative to engage the central threaded section of the worm gear, whereby rotating the threaded plug in engagement with the threaded section, a compressive force is exerted upon the worm gear, wherein the housing comprises a first distal housing section which includes a threaded section operative to receive the threaded plug, and a second distal housing section which includes a groove operative to receive the retaining ring.

Preferably, at least one of the first bearing and the second bearing comprises one of a roller bearing and a ball bearing.

Preferably, the roller bearing comprises one of a tapered roller bearing, a cylindrical roller bearing, a spherical roller bearing, and a needle roller bearing.

Preferably, the ball bearing comprises one of a deep groove ball bearing, an angular ball bearing, and a thrust ball bearing.

Preferably, the first bearing is seated on the first distal shaft section via one of a clearance fit, a transition fit, and an interference fit.

Preferably, the retaining ring is a circlip.

Preferably, the slew drive further comprises at least one of thread lock and sealant applied over the first distal housing section.

Preferably, the slew drive further comprises an oil seal disposed within the second distal housing section.

In another aspect, a method of assembling a slew drive is disclosed wherein the method comprises providing a threaded plug, providing a retaining ring, providing a housing comprising a first distal housing section and a second distal housing section, wherein the first distal housing section includes a threaded section operative to receive the threaded plug, wherein the second distal housing section includes a groove operative to receive the retaining ring, providing a worm gear comprising a central threaded section, a first distal shaft section including a first shoulder, and a second distal shaft section including a second shoulder, providing a first bearing seated on the first distal shaft section and abutting the first shoulder and the threaded plug, providing a second bearing seated on the second distal shaft section and abutting the second shoulder and the retaining ring, and providing a worm wheel comprising worm-wheel teeth operative to engage the central threaded section of the worm gear, whereby rotating the threaded plug in engagement with the threaded section, a compressive force is exerted upon the worm gear.

Preferably, the method further comprises providing at least one of thread lock and sealant applied over the first distal housing section.

Preferably, the method further comprises providing an oil seal disposed within the second distal housing section.

### DESCRIPTION OF THE DRAWINGS

FIG. 1A shows a left perspective view of the front side of a conventional slew drive which includes a housing having an end plate which is secured to the housing using 4 bolts.

FIG. 1B shows a right perspective view of the front side of the slew drive where a second end plate is secured to the housing using 4 bolts.

FIG. 1C shows a front cross-sectional front view of the slew drive which shows a worm gear engaged with a worm wheel, two tapered roller bearings fitted into both ends of the housing and the worm gear is fitted into the inner races of the bearings, the end plates abutting the housing and the bearings, the bolts used to secure the worm gear in the axial direction while imparting an axial compressive force on the worm gear to enhance and improve teeth engagement between the worm gear and the worm wheel. A seal is disposed within the end plate to prevent the lubricant from exiting the housing.

FIG. 2A shows a left perspective view of the front side of a preferred embodiment of an integrated slew drive illustrating a distal housing section of a housing included in the slew drive.

FIG. 2B shows a right perspective view of the rear side of the integrated slew drive of FIG. 2A illustrating the other distal housing section of the slew drive housing.

FIG. 3A shows a left perspective cross-sectional view of a preferred embodiment of an integrated slew drive having a slew drive housing which comprises a first distal housing section having a threaded section and a second distal housing section having a groove. The first distal housing section receives a threaded plug that threads into the threaded section. The groove is configured to receive a retaining ring.

FIG. 3B shows a front cross-sectional view of the front side of the slew drive of FIG. 3A.

FIG. 4 shows an exploded cross-sectional view of a preferred embodiment of an integrated slew drive including a threaded plug, a retaining ring, a seal, two tapered roller bearings, a worm gear, a worm wheel, and a housing having a first distal housing section and a second distal housing section.

### DETAILED DESCRIPTION OF THE PRESENTLY PREFERRED EMBODIMENTS

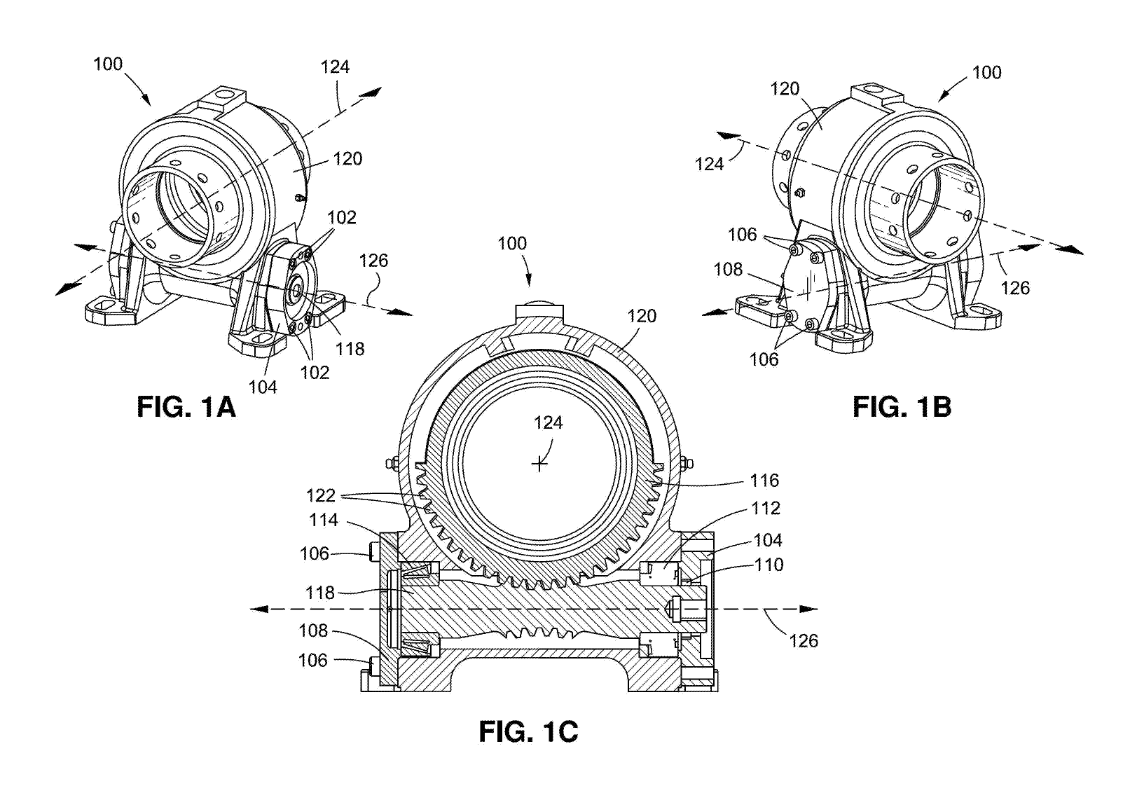

FIG. 1A depicts a left perspective view of the front side of a conventional slew drive 100 which includes a housing 120 having an end plate 104 which is secured to the housing 120 utilizing four bolts 102. The end plate 104 includes a circular hole where an end section of a worm gear 118 partially protrudes out of the hole to be driven by a reducer assembly and a motor (not shown).

FIG. 1B depicts a right perspective view of the front side of the slew drive 100 shown in FIG. 1A where a second end plate 108 is secured to the housing 120 using four bolts 106. The end plates 104 and 108 are commonly made from steel which add considerable weight to the slew drive 100. In addition to adding unwanted weight to the slew drive 100, the end plates 104 and 108 require eight bolts, i.e., bolts 102 and 106, to couple with the housing 120, adding considerable labor to the total assembly and/or disassembly of the slew drive 100.

FIG. 1C depicts a front cross-sectional front view of the slew drive 100 shown in FIGS. 1A and 1B, where the worm gear 118 is engaged with a worm wheel 116. Specifically, a central threaded section of the worm gear 118 engages worm-wheel teeth 122 of the worm wheel 116. The worm gear 118 rotates along its axial axis 126 which in turn rotates the worm wheel 116 along its axial axis 124. A motor and reducer assembly (not shown) are used to drive the worm gear 118 which in turn drives the worm wheel 116. The axes 124 and 126 are ordinarily perpendicular but can be oriented at a different angle depending on the application.

In this configuration, two tapered roller bearings 112 and 114 are fitted into both ends of the housing 120. The worm gear 118 is fitted into the inner races of the bearings 112 and 114. The end plates 104 and 108 abut the housing 120 and the bearings 112 and 114. The bolts 102 (not visible in this cross-sectional view) and bolts 106 are used to secure the worm gear in the axial direction while imparting an axial compressive force on the worm gear 118 to enhance and improve teeth engagement between the worm gear 118 and worm wheel 116. A seal 110 is disposed within the end plate 104 to prevent the lubricant from exiting the housing 120.

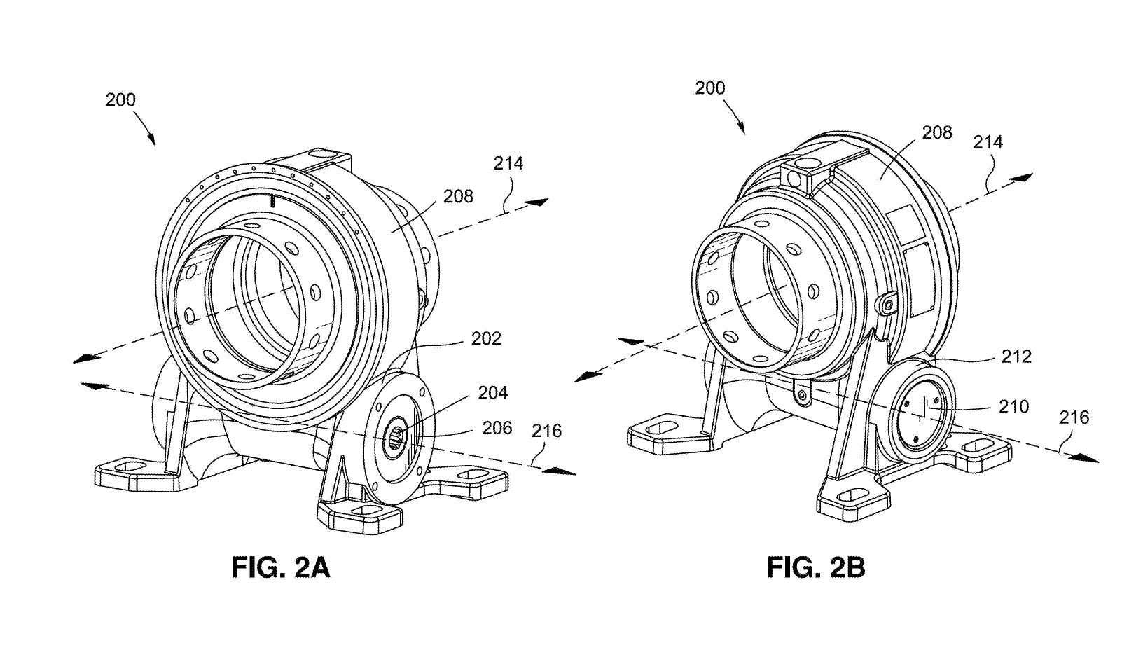

FIG. 2A depicts a left perspective view of the front side of a preferred embodiment of an integrated slew drive 200 illustrating a distal housing section 202 of a housing 208 included in the slew drive 200. A worm gear 204 partially protrudes out of a hole that has been cut into an oil seal 206, the latter being used to seal the lubricants within the housing 208. Comparing the slew drive 200 with that of the conventional slew drive 100, it can readily be seen that the integrated slew drive 200 does not require an end plate such as the end plate 104 and bolts such as the bolts 102, used in the slew drive 100, thereby, reducing the overall weight of the slew drive 200 and the labor to assemble it.

FIG. 2B depicts a right perspective view of the rear side of the integrated slew drive 200 shown in FIG. 2A. Another distal housing section 212 of the housing 208 of the slew drive 200 is used to receive a threaded plug 210. Comparison of this side of the slew drive 200 with the corresponding side of the slew drive 100 shows the elimination of the end plate 108 and bolts 106, further reducing the total weight of the slew drive 200 and the labor required for its assembly.

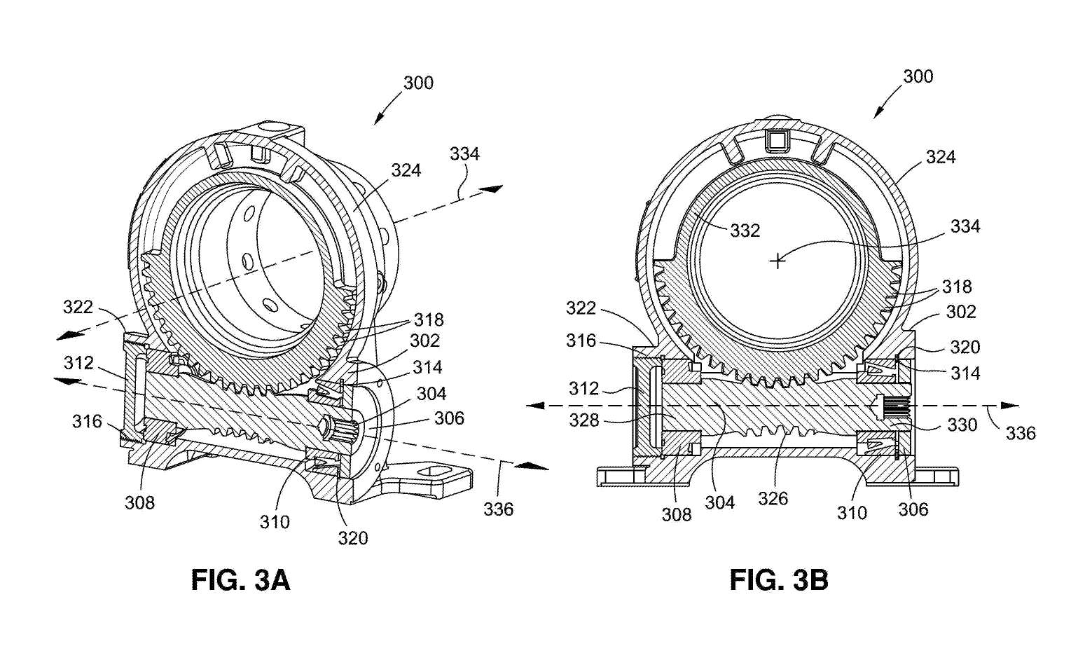

FIG. 3A depicts a left perspective cross-sectional view of a preferred embodiment of an integrated slew drive 300. The slew drive 300 comprises a housing 324 which comprises a first distal housing section 322 having a threaded section 316. The housing 324 further includes a second distal housing section 302 having a groove 320. The first distal housing section 322 receives a threaded plug 312 that threads into the threaded section 316. The groove 320 is machined into the second distal housing section 302 to receive a retaining ring 314. In one instance, the retaining ring 314 is a circlip.

A worm gear 304 is secured to the slew drive housing 324 by a first bearing 308 and a second bearing 310. The first bearing 308 and the second bearing 310 may be selected from a variety of bearings depending on the application. For instance, roller bearings and/or ball bearings can be utilized to secure the worm gear 304 to the housing 324. Roller bearings may be any one of a tapered roller bearing, a cylindrical roller bearing, a spherical roller bearing, and a needle roller bearing. Ball bearings may be any one of a deep groove ball bearing, an angular ball bearing, and a thrust ball bearing. In this preferred embodiment, the first bearing 308 and the second bearing 310 are both tapered roller bearings.

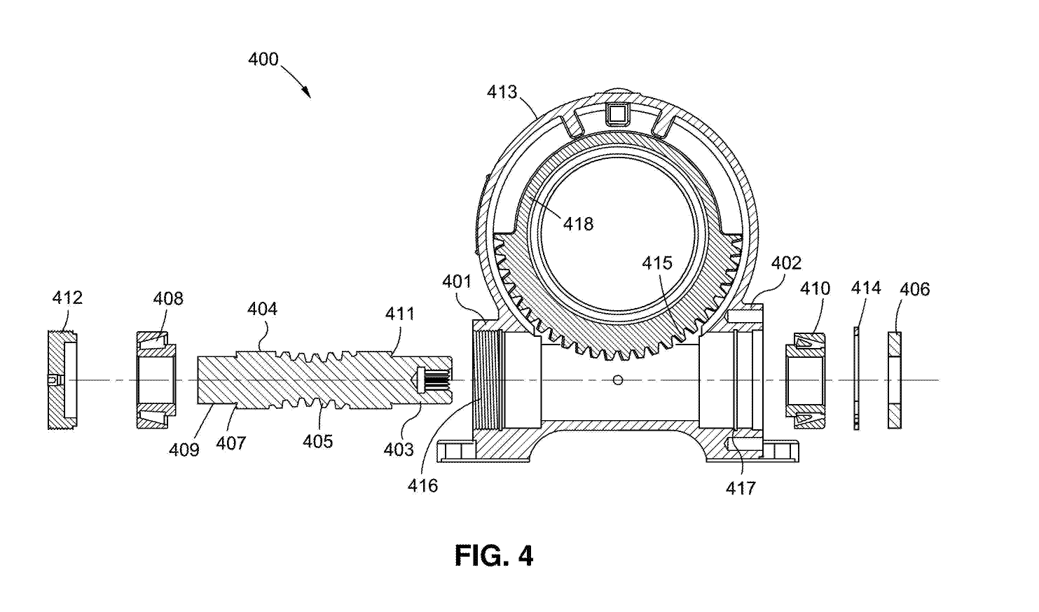

FIG. 3B depicts a front cross-sectional view of the front side of the slew drive 300 shown in FIG. 3A. The worm gear 304 comprises a central threaded section 326, a first distal shaft section 328 having a first shoulder (see FIG. 4), and a second distal shaft section 330 having a second shoulder (see FIG. 4). The central threaded section 326 of the worm gear 304 engages worm-wheel teeth 318 of a worm wheel 332. The worm gear 304 rotates around its axial axis 336 and rotates the worm wheel 332 around its axial axis 334.

The first tapered roller bearing 308 is seated on the first distal shaft section 328, abutting the first shoulder and the plug 312, and the second tapered roller bearing 310 is seated on the second distal shaft section 330, abutting the second shoulder and the retaining ring 314. The first tapered roller bearing 308 may be seated on the first distal shaft section 328 via a variety of fits, such as a clearance fit, a transition fit, and an interference fit. Similarly, the second tapered roller bearing 310 may be seated on the first distal shaft section 328 via a variety of fits, such as a clearance fit, a transition fit, and an interference fit. A seal, such as an oil, 306 is seated on the second distal shaft section 330, abutting the retaining ring 314 to prevent lubricant from exiting the housing 324.

As the threaded plug 312 is rotated in engagement with the threaded section 316 of the first distal housing section 322 of the housing 324, an axial compressive force is exerted upon the worm gear 304 through the first tapered roller bearing 308 to ensure improved engagement between the thread section 326 of the worm gear 304 and the worm-wheel teeth 318 of the worm wheel 332. The retaining ring 314 exerts the same magnitude compressive force on the worm gear 304 but in the opposite direction through the second tapered roller bearing 310.

FIG. 4 depicts an exploded cross-sectional view of a preferred embodiment of an integrated slew drive 400. The slew drive 400 comprises a housing 413 which includes a first distal housing section 401 having a threaded section 416. The housing 413 further includes a second distal housing section 402 which includes a groove 417. The slew drive 400 further comprises a threaded plug 412 and a retaining ring 414. The first distal housing section 401 receives the threaded plug 412 that threads into the threaded section 416. The retaining ring 414 is disposed in the groove 417.

The slew drive 400 further comprises a worm gear 404. The worm gear 404 comprises a central threaded section 405, a first distal shaft section 409 having a first shoulder 407, and a second distal shaft section 403 having a second shoulder 411. The slew drive 400 further comprises a first tapered roller bearing 408 and a second tapered roller bearing 410. The worm gear 404 is secured to the housing 413 by the first tapered roller bearing 408 and the second tapered roller bearing 410. The first tapered roller bearing 408 is seated on the first distal shaft section 409, abutting the first shoulder 407 and the plug 412. The second tapered roller bearing 410 is seated on the second distal shaft section 403, abutting the second shoulder 411 and the retaining ring 414.

The slew drive 400 further comprises a worm wheel 418 having worm-wheel teeth 415. The central threaded section 405 of the worm gear 404 engages the worm-wheel teeth 415 of the worm wheel 418. As the threaded plug 412 is rotated in engagement with the threaded section 416 of the first distal housing section 401 of the housing 413, an axial compressive force is exerted upon the worm gear 404 ensuring improved engagement between the threaded section 405 of the worm gear 404 and the worm-wheel teeth 415 of the worm wheel 418. The slew drive 400 further comprises an oil seal 406 which is seated on the second distal shaft section 403 and abutting the retaining ring 414 to prevent lubricant from exiting the housing 413.

In a preferred embodiment, the retaining ring 414 is disposed in the groove 417 and the second tapered roller bearing 410 is disposed within the second distal housing section 402 and to the left of the retaining ring 417. In one instance, an interference fit is used to dispose the second tapered roller bearing 410 within the second distal housing section 402. The worm gear 404 is inserted in the inner race of the second tapered roller bearing 410 such that the second tapered roller bearing 410 is seated on the second distal shaft section 403 and abutting the second shoulder 411. The first tapered roller bearing 408 is then seated on the first distal shaft section 409 until it abuts the first shoulder 407. The worm wheel 418 is then disposed within the housing 413 and engages the threaded section 405 of the worm gear 404. The oil seal 406 is then seated on the second distal shaft section 403 abutting the retaining ring 414 so as to prevent lubricant from exiting the housing 413. The plug 412 is then inserted into the first distal housing section 401 and rotated in engagement with the threaded section 416 to impart an axial compressive force upon the worm gear 404 to improve engagement between the threaded section 405 of the worm gear 404 and the worm-wheel teeth 415 of the worm wheel 418.

The foregoing explanations, descriptions, illustrations, examples, and discussions have been set forth to assist the reader with understanding this invention and further to demonstrate the utility and novelty of it and are by no means restrictive of the scope of the invention. It is the following claims, including all equivalents, which are intended to define the scope of this invention.

What is claimed is:

1. A slew drive, comprising:
(a) a threaded plug;
(b) a retaining ring;
(c) a housing comprising a first distal housing section and a second distal housing section, wherein the first distal housing section includes a threaded section operative to receive the threaded plug, wherein the second distal housing section includes a groove operative to receive the retaining ring;
(d) a worm gear comprising a central threaded section, a first distal shaft section including a first shoulder, and a second distal shaft section including a second shoulder;
(e) a first bearing seated on the first distal shaft section and abutting the first shoulder and the threaded plug;
(f) a second bearing seated on the second distal shaft section and abutting the second shoulder and the retaining ring; and
(g) a worm wheel comprising worm-wheel teeth operative to engage the central threaded section of the worm gear;
whereby rotating the threaded plug in engagement with the threaded section, a compressive force is exerted upon the worm gear.

2. The slew drive of claim 1, wherein at least one of the first bearing and the second bearing comprises one of a roller bearing and a ball bearing.

3. The slew drive of claim 2, wherein the roller bearing comprises one of a tapered roller bearing, a cylindrical roller bearing, a spherical roller bearing, and a needle roller bearing.

4. The slew drive of claim 2, wherein the ball bearing comprises one of a deep groove ball bearing, an angular ball bearing, and a thrust ball bearing.

5. The slew drive of claim 1, wherein the first bearing is seated on the first distal shaft section via one of a clearance fit, a transition fit, and an interference fit.

6. The slew drive of claim 1, wherein the retaining ring is a circlip.

7. The slew drive of claim 1, further comprising at least one of thread lock and sealant applied over the first distal housing section.

8. The slew drive of claim 1, further comprising an oil seal disposed within the second distal housing section.

9. A housing in combination with a slew drive, wherein the slew drive comprises a threaded plug, a retaining ring, a worm gear comprising a central threaded section, a first distal shaft section including a first shoulder, and a second distal shaft section including a second shoulder, a first bearing seated on the first distal shaft section and abutting the first shoulder and the plug, a second bearing seated on the second distal shaft section and abutting the second shoulder and the retaining ring, and a worm wheel comprising worm-wheel teeth operative to engage the central threaded section of the worm gear, whereby rotating the threaded plug in engagement with the threaded section, a compressive force is exerted upon the worm gear, wherein the housing comprises:
(a) a first distal housing section which includes a threaded section operative to receive the threaded plug; and
(b) a second distal housing section which includes a groove operative to receive the retaining ring.

10. The housing of claim 9, wherein at least one of the first bearing and the second bearing comprises one of a roller bearing and a ball bearing.

11. The slew drive of claim 10, wherein the roller bearing comprises one of a tapered roller bearing, a cylindrical roller bearing, a spherical roller bearing, and a needle roller bearing.

12. The slew drive of claim 10, wherein the ball bearing comprises one of a deep groove ball bearing, an angular ball bearing, and a thrust ball bearing.

13. The housing of claim 9, wherein the first bearing is seated on the first distal shaft section via one of a clearance fit, a transition fit, and an interference fit.

14. The housing of claim 9, wherein the retaining ring is a circlip.

15. The housing of claim 9, wherein the slew drive further comprises at least one of thread lock and sealant applied over the first distal housing section.

16. The housing of claim 9, wherein the slew drive further comprises an oil seal disposed within the second distal housing section.

17. A method of assembling a slew drive, comprising:
(a) providing a threaded plug;
(b) providing a retaining ring;
(c) providing a housing comprising a first distal housing section and a second distal housing section, wherein the first distal housing section includes a threaded section operative to receive the threaded plug, wherein the second distal housing section includes a groove operative to receive the retaining ring;
(d) providing a worm gear comprising a central threaded section, a first distal shaft section including a first shoulder, and a second distal shaft section including a second shoulder;
(e) providing a first bearing seated on the first distal shaft section and abutting the first shoulder and the threaded plug;
(f) providing a second bearing seated on the second distal shaft section and abutting the second shoulder and the retaining ring; and
(g) providing a worm wheel comprising worm-wheel teeth operative to engage the central threaded section of the worm gear;
whereby rotating the threaded plug in engagement with the threaded section, a compressive force is exerted upon the worm gear.

18. The method of claim 17, further comprising providing at least one of thread lock and sealant applied over the first distal housing section.

19. The method of claim 17, further comprising providing an oil seal disposed within the second distal housing section.
